(19) United States
(12) Patent Application Publication
(10) Pub. No.: US 2004/0246870 A1
(43) Pub. Date: Dec. 9, 2004

(54) High-density multi-layer recording medium and an apparatus for writing to or reading from such a recording medium

(76) Inventors: Jin Yong Kim, Kyunggi-do (KR); Kyung Chan Park, Seoul (KR); Seong Yun Jeong, Seoul (KR)

Correspondence Address: HARNESS, DICKEY & PIERCE, P.L.C., P.O. BOX 8910, RESTON, VA, 20195, US

(21) Appl. No.: 10/793,011

(22) Filed: Mar. 5, 2004

(30) Foreign Application Priority Data
Jun. 4, 2003 (WO) PCT/KR03/01095

(51) Int. Cl. G11B 7/20; G11B 13/00

(52) U.S. Cl. 369/94; 369/288; 369/283

(57) ABSTRACT

A high-density multi-layer recording medium is provided with a first recording layer arranged within a layer of transparent material a first distance from a light incident surface of a recording medium and a second recording layer arranged a greater second distance from the light incident layer. The material forming the layer of transparent material on the recording medium typically has an index of refraction between about 1.45 and 1.70 with the first and second recording layers being arranged in an annular section of the substrate between about 63.5 μm and about 115.5 μm from the light incident surface with the separation between the two recording layer being between about 14 μm and 30 μm. Also disclosed is an apparatus for reading such recording mediums including a light source and a lens assembly arranged and configured to produce a light beam that enters the recording medium through the light incident surface and is focused on the two recording layers.

### CROSS-REFERENCE TO RELATED APPLICATIONS

This non-provisional application claims priority under 35 U.S.C. § 119 to PCT Application No. PCT/KRO3/01095, filed on Jun. 4, 2003, in the Korean Intellectual Property Office, the contents of which are hereby incorporated herein by reference in its entirety

### BACKGROUND OF THE INVENTION

1. Field of the Invention

The present invention relates to a high-density multi-layer recording medium having first and second recording layers, both of which are positioned between a central plane that bisects the thickness of the recording medium and a light incident surface of the recording medium.

2. Description of the Related Art

FIG. 1 shows the structure of a conventional DVD (Digital Versatile Disc). As shown in FIG. 1, the DVD 10 has a diameter of 120 mm, a thickness of 1.20 mm and a center hole having a diameter of 15 mm. The DVD 10 also includes a clamping region having a diameter of 44 mm adapted to be clamped by a turntable and damper (not shown) included in a recording medium apparatus arranged and configured to read and/or write a DVD.

The DVD 10 has a recording layer 12, in which data is recorded in a pit pattern. The recording layer 12 of the DVD 10 is positioned at a depth of about 0.60 mm from a disc surface 14 facing an objective lens 1 of an optical pickup device (not shown) included in the recording medium apparatus. The objective lens 1 of the optical pickup device for the DVD 10 typically has a numerical aperture NA of 0.6.

FIG. 2 shows the structure of a high-density single layer DVD. As shown in FIG. 2, the high-density single layer DVD 20, like DVD 10, has a diameter of 120 mm, a thickness of 1.20 mm and a center hole having a diameter of 15 mm. The DVD 20 also includes a clamping region having a diameter of 44 mm adapted to be clamped by a turntable and damper (not shown) included in an recording medium apparatus arranged and configured to read and/or write such a DVD. The high-density single layer DVD 20 has a data recording layer 22, which is positioned at a depth of about 0.1 mm from a disc surface 24 facing an objective lens 2 of an optical pickup device (not shown) included in the recording medium apparatus. The objective lens 2 of the optical pickup device used with the high-density single layer DVD 20 has a numerical aperture NA equal to 0.85, which is a relatively large value in comparison with that of the objective lens 1 used with a conventional DVD 10.

The objective lens 2 of the optical pickup device also utilizes a shorter wavelength laser beam having a wavelength shorter than that used in the DVD 10 for the reproduction or recording of high-density data. That is, for the reproduction or recording of high-density data, the DVD 10 uses a laser beam having a wavelength of 650 nm, whereas the high-density single layer DVD 20 uses a laser beam having a wavelength of 405 nm.

By utilizing the shorter wavelength laser beam, increasing the numerical aperture of the objective lens and positioning the objective lens 2 of the optical pickup device close to the recording layer of the high-density single layer DVD 20, it is possible to form a small beam spot on a pit of high data density by intensively focusing the laser beam and to reduce the thickness of the transparent cover layer that must be traversed by the shorter wavelength laser beam. As a result, the variation of the laser beam's properties and the generation of aberrations can be reduced.

In recent years many companies have developed high-density multi-layer recording media, for example, a high-density multi-layer DVD or high-density multi-layer blu-ray disc (hereinafter referred to as an “high-density multi-layer BD”), as substitutes for the high-density single layer DVD. These high-density multi-layer recording media can record and store a large quantity of video and audio data, as a result of having about twice the capacity of the high-density single layer DVD.

In the case of the high-density multi-layer recording medium as stated above, however, there is no way to restrict the level of WFA (wave front aberration) effectively. Wave front aberration is inevitably generated both as a result of spherical aberrations produced by variations in the material thickness between the light incident surface of the recording medium and respective recording layers and as a result of coma aberrations resulting from the tilt of the objective lens included in the optical pickup device.

### SUMMARY OF THE INVENTION

The exemplary embodiments of the present invention provide a new high-density multi-layer recording medium having at least first and a second recording layers, the recording medium being configured to reduce the generation of wave front aberrations due to variations in the substrate thickness between a light incident surface of the disc and the respective first and second recording layers.

Exemplary embodiments of the present invention include a new high-density multi-layer recording medium having first and second recording layers. Recording media according to the exemplary embodiments of the invention are configured so as to reduce wave front aberrations generated both as a result of spherical aberrations produced by variations in the material thickness between the light incident surface of the recording medium (i.e., a cover layer and, if present a protective coating) and the respective first and second recording layers and as a result of coma aberrations resulting from the tilt of an objective lens included in an optical pickup device.

Exemplary embodiments of the present invention provide a high-density multi-layer recording medium having at least first and a second recording layers positioned to one side of a central plane bisecting the thickness of the disc and close to a disc surface. The positioning of the first recording layer may be characterized by a thickness measured between the light incident surface of the disc and the first recording layer, i.e., the recording layer arranged closest to the surface. Similarly, the positioning of the last recording layer may be characterized by a thickness measured between the light incident surface of the disc and the last recording layer, i.e., the recording layer arranged furthest from the surface. A reference plane corresponding generally to the positioning of the recording layer in a high-density single layer recording medium may be defined at a point midway between the first and last recording layers in the multi-layer recording medium. In a dual-layer recording medium, for example, the last recording layer will be a second recording layer with the reference plane being arranged midway between the first and second recording layers.

An exemplary embodiment of the present invention is provided in a high-density multi-layer recording medium having first and second recording layers positioned to one side of a central plane bisecting the thickness of the disc and close to a light incident surface. The positioning of the first recording layer may be characterized by a first transmission stack thickness t1 measured from the light incident surface of the recording medium to the first recording layer. The positioning of the second recording layer may be similarly characterized by a second transmission stack thickness t2 measured from the light incident surface of the recording medium to the second recording layer. In recording mediums prepared according to the exemplary embodiments of the invention, the thickness t1 will be is at least 70 μm, the thickness t2 will be no greater than 108 μm, and the separation distance between the first and second recording layers will be between about 14 μm and 30 μm, preferably between about 14 μm and 24 μm, and, more preferably, about 19 μm.

The thickness of the cover layer between the light incident surface of the recording medium and the recording layer in the high-density single layer recording medium, a thickness that may be used to define a reference plane for the high-density multi-layer recording medium, may be 0.10 mm and the distance between the first and the second recording layers may be 0.02 mm, resulting in first and second transmission stack thicknesses of 0.09 mm and 0.11 mm, respectively. The first and second transmission stack thicknesses may be also be adjusted to accommodate combinations of cover layers and spacer layers having refractive indices within a range of 1.45 to 1.70. For example, in those instances in which the refractive index of the cover and spacer layers equals 1.60, the first and second transmission stack thicknesses may be set at 79.5 μm±5 μm, and 98.5 μm±5 μm, respectively.

### BRIEF DESCRIPTION OF THE DRAWINGS

The features and other advantages of the present invention will be more clearly understood from the following detailed description taken in conjunction with the accompanying drawings, in which:

FIG. 1 shows the structure of a conventional DVD;

FIG. 2 shows the structure of a conventional high-density single layer DVD;

FIG. 3 shows the example structure of an exemplary embodiment of high-density multi-layer recording medium according to the present invention;

FIG. 4 is a graph for comparing variations in wave front aberration resulting from spherical aberrations due to variations in the material thickness between the light incident surface and the recording layers in the high-density multi-layer recording medium;

FIG. 5 shows the structure of an exemplary embodiment of a high-density multi-layer recording medium in accordance with the present invention;

FIGS. 6A to 6C are graphs for comparing variations in wave front aberration resulting from coma errors caused by the tilt of an objective lens with spherical aberrations caused by variations in the material thickness between the light incident surface and the recording layers in the high-density multi-layer recording medium;

FIG. 7 is a graph showing the range of the material thicknesses between the light incident surface of the recording medium and the first and second recording layers that may be utilized in a high-density multi-layer recording medium according to an exemplary embodiment of the present invention; and

FIG. 8 shows the structure of a high-density multi-layer recording medium in accordance with an exemplary embodiment of the present invention.

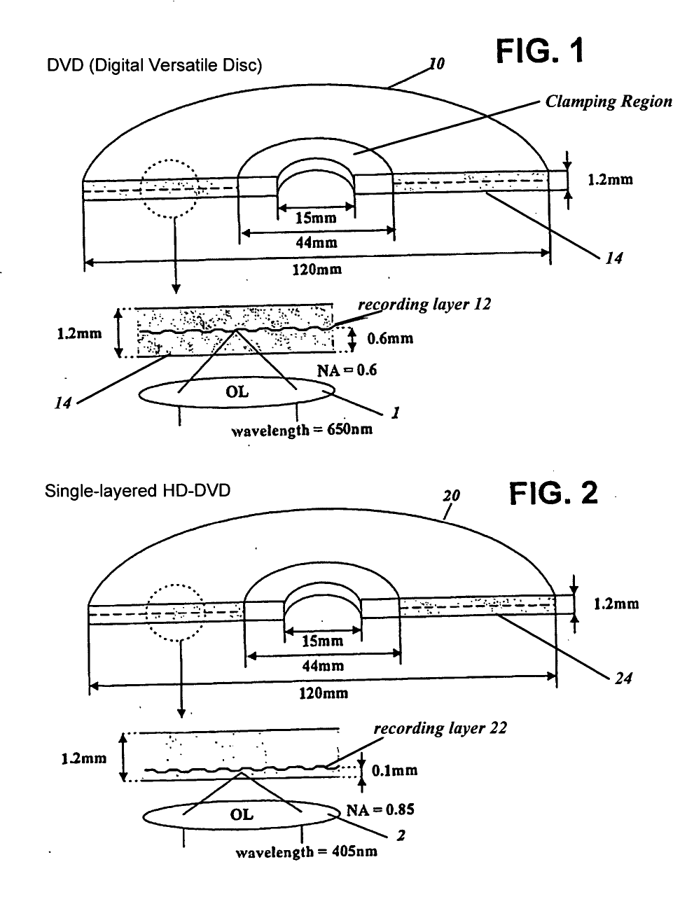

### DETAILED DESCRIPTION OF EXEMPLARY EMBODIMENTS

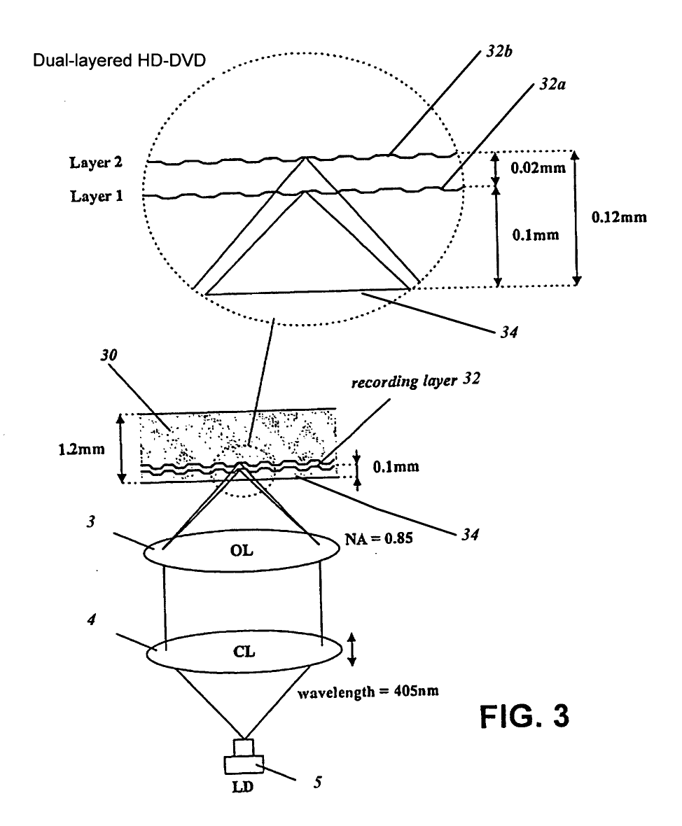

As illustrated in FIG. 3, a conventional high-density multi-layer DVD 30 has a diameter of 120 mm, a thickness of 1.20 mm and a center hole having a diameter of 15 mm. DVD 30 also includes a clamping region having a diameter of 44 mm that is adapted to be clamped by a turntable and damper (not shown) included in an recording medium apparatus. The high-density multi-layer DVD 30 comprises a first recording layer 32a, which is formed in the same general manner as the recording layer of a general high-density single layer DVD, and a second recording layer 32b spaced apart from the first recording layer by a distance of 0.02 mm. In detail, as shown in FIG. 3, the first recording layer 32a of the high-density multi-layer DVD 30 is positioned at a depth of 0.10 mm from a disc surface 34 that faces an objective lens 3 of an optical pickup device included in the recording medium apparatus, and the second recording layer 32b is positioned at a depth of 0.12 mm from the disc surface.

The objective lens 3 of the optical pickup device for the high-density multi-layer recording medium 30 has a numerical aperture (“NA”) of 0.85 and utilizes a laser device 5 and a collimator lens 4 to produce a light beam having a wavelength of 405 nm for the reproduction or recording of high-density data in the first and second recording layers, in much the same manner as the high-density single layer DVD 20.

Where the optical pickup device adopting the numerical aperture of 0.85 and the wavelength of 405 nm is used to reproduce or record data in the recording layers, a de-focusing margin (“DFM”) due to the material thickness between the light incident surface of the recording medium and the recording layers is reduced considerably according to equation (1):

$$DFM = \frac{λ}{{( NA )}^{4} Δ t} \qquad ( 1 )$$

where λ is the wavelength in nanometers, NA is the numerical aperture, and Δt is the variation in the thickness of the material of the cover layer arranged between the light incident surface of the recording medium and the recording layers.

It should be noted that increasing the numerical aperture of the objective lens and decreasing the wavelength both tend to reduce the DFM resulting from the same magnitude of variation in the material thickness when compared with a conventional DVD. This reduction in the DFM ultimately acts to increase system noise. Conversely, an arrangement in which the first recording layer is formed 0.10 mm from the light incident surface of the recording medium and second recording layer is formed 0.08 mm from the surface of the substrate, will tend to increase the DFM when compared with a configuration in which the first recording layer is formed at a depth of 0.10 mm and the second recording layer is formed at a depth of 0.12 mm. Also, in addition to the DFM, the spherical aberration, the coma aberration and the resulting WFA must be considered when positioning the recording layers with respect to the recording medium surface.

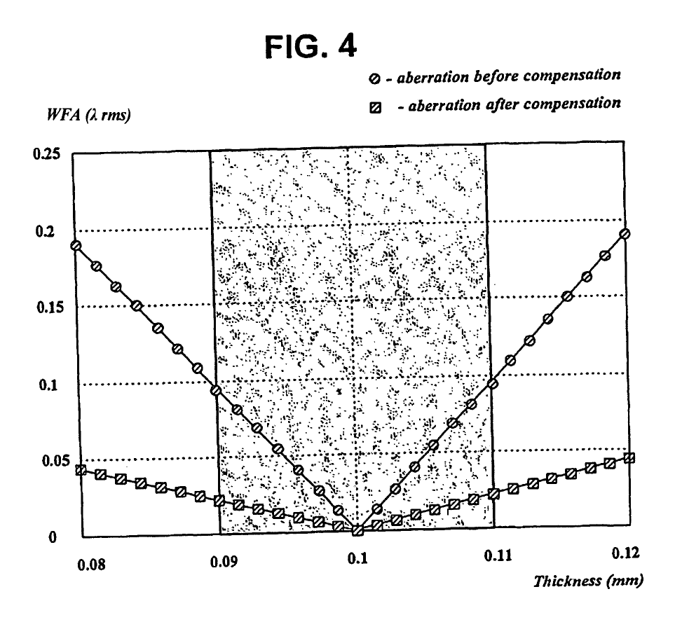

Assuming that the material thickness between the light incident surface of the recording medium and the first recording layer is 0.10 mm and the WFA of a beam spot formed on the first recording layer is zero, the WFA will vary with the thickness between the light incident surface of the recording medium and the second recording layer as shown in the graph of FIG. 4. For example, where the thickness between the light incident surface of the recording medium and the second recording layer has a nominal value of 0.08 mm or 0.12 mm, the WFA will have a value of about 0.18×rms.

In general, however, total aberration should typically not exceed about 0.075 λrms in order to maintain a sufficiently low error rate for the optical system, a level that will be used hereinafter as the general upper limit for total aberration for exemplary embodiments of the invention. As reflected in FIG. 4, when the thickness between the second recording layer and the substrate surface is less than 0.08 mm or greater than 0.12 mm, the WFA exceeds the upper limit of 0.075 λrms that has been established for an actual system.

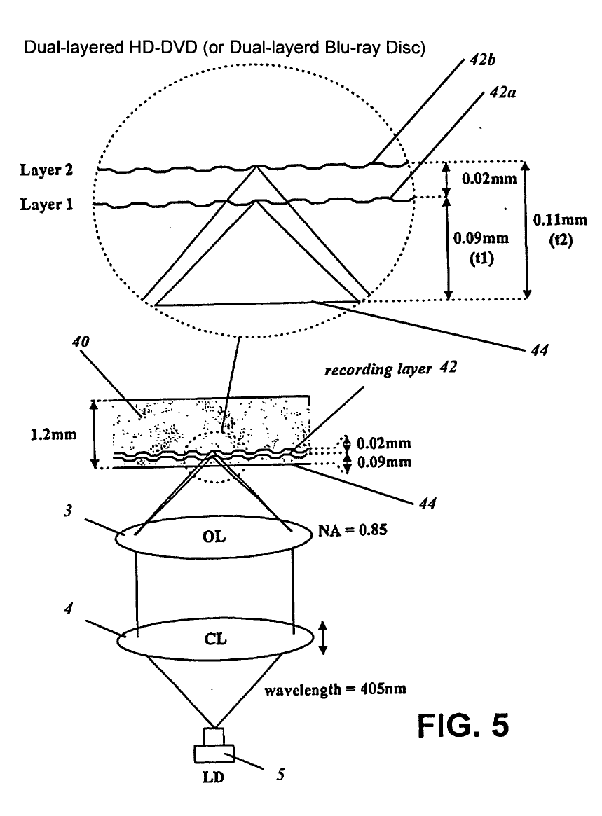

As stated above, when the thickness from the light incident surface of the recording medium to the respective first and second recording layers are set at 0.10 mm and 0.12 mm, respectively, or set at 0.10 mm and 0.08 mm, respectively, the resulting WFA is about 0.18 λrms, a level that is generally unacceptable for satisfactory operation of a typical system. Several methods are available for reducing the WFA including the use of an accurately positioned collimator lens 4 in the recording medium apparatus, as illustrated in FIG. 5, or installing an additional liquid crystal device (not shown) or similar device in the recording medium apparatus. Such methods tend to reduce the WFA to about 0.045 λrms when the thickness between the light incident surface of the recording medium and the second recording layer is 0.08 mm or 0.12 mm.

FIG. 5 shows the structure of a high-density multi-layer recording medium in accordance with an exemplary embodiment of the present invention in which the high-density multi-layer recording medium 40, has first 42a and second 42b recording layers. The first thickness t1 from the light incident surface 44 of the recording medium to the first recording layer 42a corresponds to a value obtained by subtracting half the distance between the first and second recording layers 42a, 42b from the thickness from the light incident surface 24 of a recording medium to a recording layer 22 in a conventional high-density single layer recording medium as illustrated in FIG. 2. The second thickness t2 from the light incident surface 44 of the recording medium to the second recording layer 42b corresponds to a value obtained by adding half the distance between the first and second recording layers 42a, 42b to the thickness from the light incident surface of the recording medium to the recording layer in the conventional high-density single layer recording medium 20.

High-density multi-layer DVDs or high-density multi-layer BDs according to the exemplary embodiments of the present invention will typically have a diameter of 120 mm, a thickness of 1.2 mm and a center hole having a diameter of 15 mm, as well as a clamping region having a diameter of 44 mm that is adapted to be clamped by a turntable and damper (not shown) included in an recording medium apparatus. The exemplary high-density multi-layer DVD 40 according to the present invention includes a first recording layer positioned 0.09 mm from the disc surface 44 facing an objective lens 3 of an optical pickup device included in the recording medium apparatus, and a second recording layer positioned 0.11 mm from the disc surface facing the objective lens 3 of the optical pickup device.

Applying the conditions as stated above regarding the data presented in FIG. 4, when the first and second thicknesses t1 and t2, measured from the light incident surface of the recording medium to the first and second recording layers respectively, are set at 0.09 mm and 0.11 mm, the resulting WFA is about 0.08 λrms, a level very close to the upper limit of 0.075 λrms that has been found acceptable in actual systems. Furthermore, by finely regulating the positioning of a collimator lens 4 and the installation of an additional compensating liquid crystal device, the wave front aberration may be reduced to about 0.025 λrms. In this way, the generation of the wave front aberration due to the substrate thickness from the light incident surface of the recording medium to the recording layers can be reduced effectively.

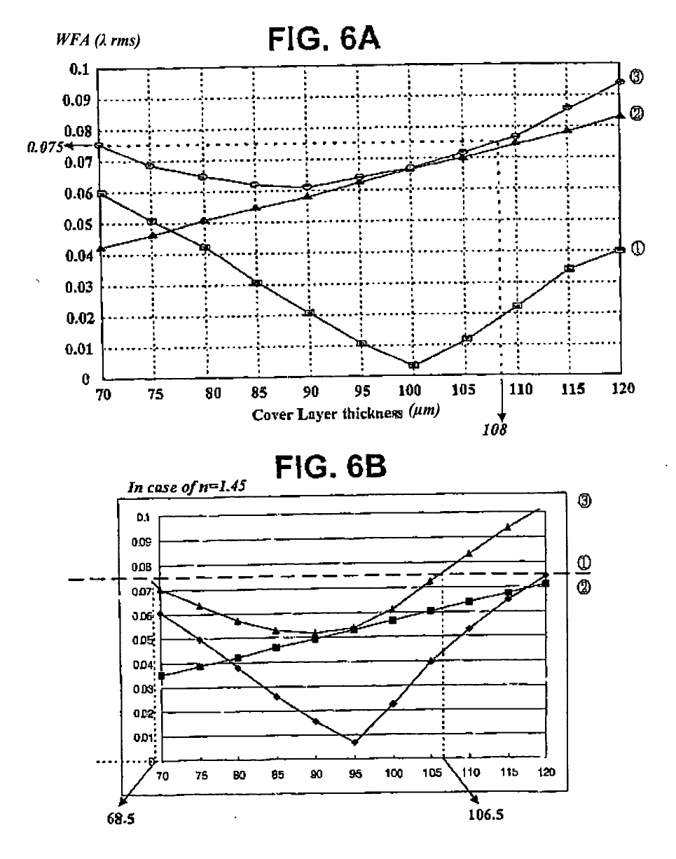

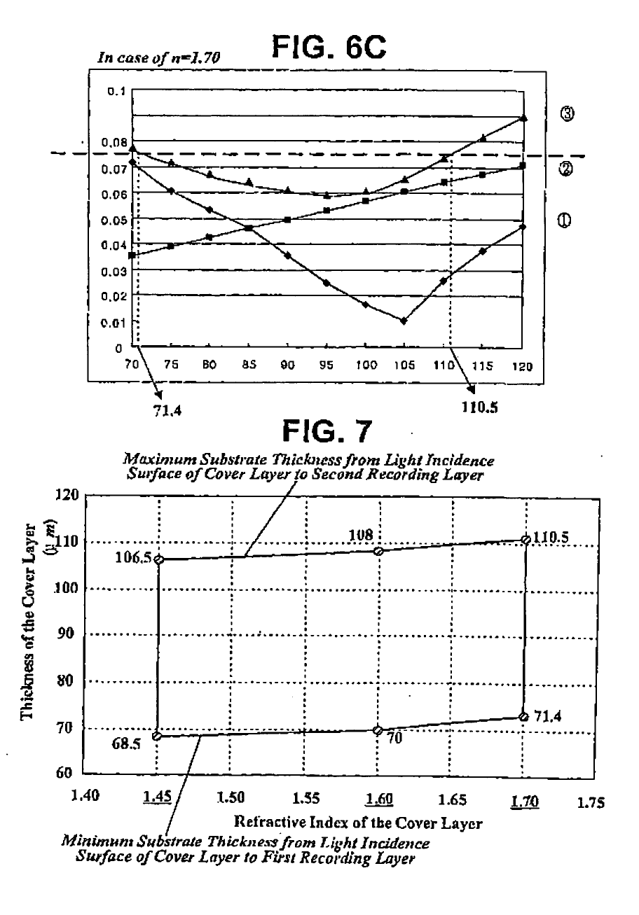

FIGS. 6A to 6C are graphs for comparing the variation in WFA resulting from the tilt of the objective lens, i.e., coma aberration, with that the aberration resulting from variations in the thickness from the light incident surface of the recording medium to recording layers in the high-density multi-layer recording medium, i.e., spherical aberration. As reflected in FIGS. 6A to 6C, the spherical aberration produced by variations in the thickness between the light incident surface of a recording medium (i.e., a cover layer) and the recording layers, assuming a 0° tilt, or tilt angle, for the objective lens included in an optical pickup device is plotted as the line \mathring{1} in each of FIGS. 6A to 6C. As used herein, the terms tilt, lens tilt or tilt angle refer to the angular deviation between the axis of an incident beam or an objective lens and an axis perpendicular to a reference plane within the disc. A tilt angle of 0° or a no-tilt state, therefore, indicates that the incident beam or the axis of the lens is perpendicular to the reference plane.

A coma aberration, resulting from an objective lens of the optical pickup device that has a tilt angle of less than 0.6°, is plotted as the line \mathring{2} in each of FIGS. 6A to 6C. A wave front aberration generated all over the recording medium resulting from the combination of the spherical aberration and coma aberration is reflected in the line plotted as \mathring{3} in each of FIGS. 6A to 6C. FIGS. 6A to 6C also include line \mathring{1}, which is generated by applying the graph shown in FIG. 4, with \mathring{2} being obtained from equation (2):

\mathring{2}=t((n²−1)/(2n²))NA³α (2)

where \mathring{1} is the thickness in μm, n is the Refractive Index, NA is the numerical aperture of the objective lens and α is angle of lens tilt, in degrees.

As a general rule, because typical optical systems will have a maximum amount of tilt of no more than about 0.6°, this angle value is used to compute the coma aberration, allowing the WFA \mathring{3} to be calculated according to equation 3:

\mathring{3}=\sqrt{1}²+\mathring{2}² (3)

where \mathring{1} is the spherical aberration produced by a variation in the material thickness from the light incident surface of a recording medium to recording layers under a no-tilt state of an objective lens and \mathring{2} is the coma aberration produced under a tilt angle of no more than 0.60.

Therefore, as shown in FIG. 6A, the thickness from the light incident surface of the recording medium to respective first and second recording layers has to be set within a range of about 70 μm to 108 μm in order to obtain a WFA of no more than 0.075 λrms. The range in values for these thicknesses is a function of the Refractive Index of the transparent material comprising the cover layer and space layer, both of which, in this instance, have been assumed to be 1.60. As reflected in FIG. 6B, a refractive index of 1.45 requires that the range of thickness from the light incident surface of the recording medium to respective first and second recording layers has to be set within a range of about 68.5 μm to 106.5 μm in order to obtain a WFA of no more than about 0.075 λrms. And finally, as reflected in FIG. 6C, for a refractive index of 1.70, the thickness from the light incident surface of the recording medium to respective first and second recording layers has to be set within a range of about 71.4 μm to 110.5 μm in order to obtain a WFA of no more than about 0.075 λrms.

FIG. 7 is a graph showing the range of the thickness between the light incident surface of a recording medium and the first and second recording layers applicable to exemplary embodiments of high-density multi-layer recording mediums in accordance with the present invention. As shown in FIGS. 6A to 6C, the target range for substrate thickness varies in accordance with the refractive index of the recording medium. For example, where the refractive index of the materials used to form the cover and space layers is 1.60, the thicknesses t1 and t2 should be between 70 μm to 108 μm respectively in order not to exceed the maximum wave front aberration value of 0.075 λrms.

Similarly, when the refractive index of the material(s) is 1.45, the corresponding thickness range will be about 68.5 μm to 106.5 μm and, when the refractive index is 1.70, the corresponding thickness range will be about 71.4 μm to 110.5 μm, in order to obtain a maximum WFA of less than 0.075 λrms. Thus, for indices of refraction between 1.45 and 1.70, the distance from the light incident surface of the recording medium to the first recording layer will be in a range of about 106.5 to 110.5 μm, and the distance from the light incident surface of the recording medium to the second recording layer will be in a range of about 68.5 to 71.4 μm.

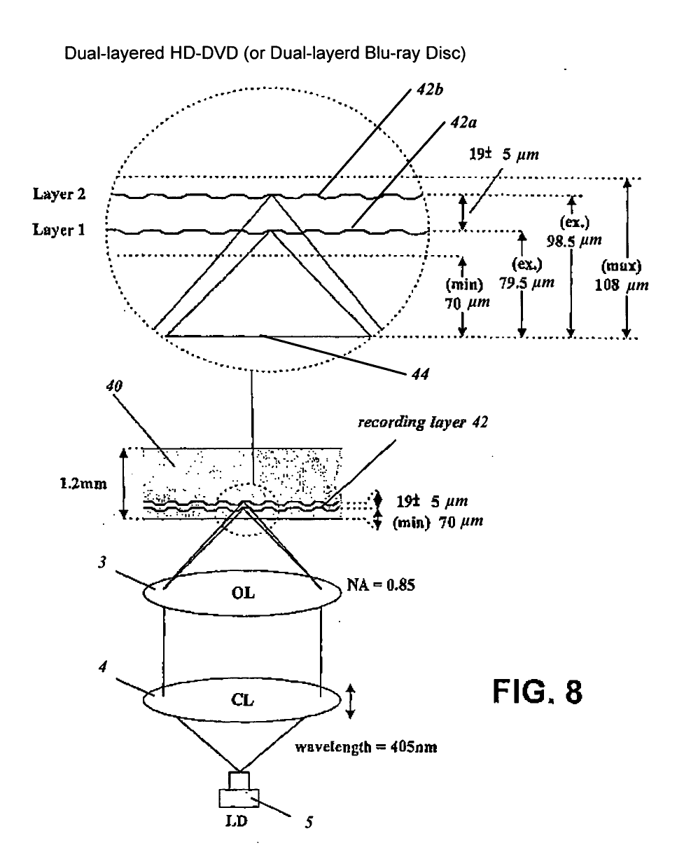

FIG. 8 illustrates the structure of the high-density multi-layer recording medium in accordance with the exemplary embodiments of the present invention, with the material thickness between the light incident surface of the recording medium and the first recording layer having a minimum value of 70 μm, the material thickness between the light incident surface of the recording medium and the second recording layer having a maximum value of 108 μm and the distance separating the first and second recording layers being within a range of 22 μm±8 μm, 25±5 μm, or, more preferably, 19 μm±5 μm.

The minimum t1 value and the maximum t2 values associated with the positioning of the first and second recording layers from the light incident surface of the recording medium have an average value of 89 μm ((70 μm+108 μm)/2). However, when the first recording layer is positioned at the minimum depth of 70 μm, the second recording layer will be positioned at a nominal depth of 89 μm to maintain the desired 19 μm spacing between the two recording layers. Similarly, when the second recording layer is positioned at a depth of 108 μm, the first recording layer will be positioned at a nominal depth of 89 μm to maintain the desired 19 μm spacing between the layers. Considering the manufacturing capabilities of conventional systems, it is believed that the first and second layers can be positioned with an accuracy on the order of ±5 μm from the light incident surface. In light of the expected accuracy of the manufacturing process, an exemplary embodiment of the invention will have first target thickness of 79.5 μm±5 μm, a second target thickness of 98.5 μm±5 μm, and a target separation thickness of 19 μm±5 μm, as indicated on FIG. 8. As will be appreciated, improvements in the manufacturing process may allow for more accurate positioning of the respective recording layers and a corresponding reduction in the variability allowed in the target thicknessess and/or the target separation thickness.

The configuration of a high-density multi-layer recording medium according to the exemplary embodiments of the invention permit a reduction in the WFA resulting from both the spherical aberration and the coma aberration. This reduction in WFA will improve the accuracy of the read and/or write process utilizing such high-density multi-layer recording mediums. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

We claim:

1. A high-density multi-layer recording medium, comprising:
a substrate including a transparent material layer, the transparent material layer having a light incident surface, an opposite surface and a substrate thickness corresponding to a distance between the light incident surface and the opposite surface;
a first recording layer; and
a second recording layer, wherein
the recording layers are located within the transparent material layer between the light incident surface and a central plane generally parallel to the light incident surface that bisects the substrate thickness; and further wherein:
the first recording layer is located at least about 63.5 μm from the light incident surface and the second recording layer is located between the first recording layer and the central plane and no more than about 115.5 μm from the light incident surface.

2. The high-density multi-layer recording medium according to claim 1, wherein:
the transparent material layer has a refractive index between about 1.45 and 1.70 and includes a cover layer arranged between the light incident surface and the first recording layer and a spacer layer arranged between the first recording layer and the second recording layer.

3. The high-density multi-layer recording medium according to claim 2, wherein:
a separation distance between the first and second recording layers is between 14 μm and 24 μm.

4. The high-density multi-layer recording medium according to claim 2, wherein:
the refractive index of the transparent material layer is about 1.60;
the first recording layer is located 79.5 μm+5 μm from the light incident surface; and
the second recording layer is located 98.5 μm±5 μm from the light incident surface.

5. The high-density multi-layer recording medium according to claim 2, wherein:
the refractive index of the transparent material layer is about 1.60;
the first recording layer is located at least 70.0 μm from the light incident surface; and
the second recording layer is located no more than 108.0 μm from the light incident surface.

6. The high-density multi-layer recording medium according to claim 2, wherein:
the refractive index of the transparent material layer is about 1.45;
the first recording layer is located at least 68.5 μm from the light incident surface; and
the second recording layer is located no more than 106.5 μm from the light incident surface.

7. The high-density multi-layer recording medium according to claim 2, wherein:
the refractive index of the transparent material layer is about 1.70;
the first recording layer is located at least 71.4 μm from the light incident surface; and
the second recording layer is located no more than 110.5 μm from the light incident surface.

8. The high-density multi-layer recording medium according to claim 5, wherein:
the first recording layer and the second recording layer are separated by a distance of between 14 μm and 24 μm.

9. The high-density multi-layer recording medium according to claim 6, wherein:
the first recording layer and the second recording layer are separated by a distance of between 14 μm and 24 μm.

10. The high-density multi-layer recording medium according to claim 7, wherein:
the first recording layer and the second recording layer are separated by a distance of between 14 λm and 24 λm.

11. The high-density multi-layer recording medium according to claim 1, wherein:
the first recording layer is located between about 63.5 μm and about 84.5 μm from the light incident surface;
the second recording layer is located between about 93.5 μm and about 115.5 μm from the light incident surface; and
the first recording layer and the second recording layer are separated by a distance of between 14 μm and 24 μm.

12. An apparatus for writing to or reading from a recording medium, comprising:
an optical pickup arranged and configured to write data to or read data from the recording medium; wherein
the recording medium includes a transparent material layer, the transparent material layer having
an index of refraction between 1.45 and 1.70,
a light incident surface,
a first recording layer arranged within the transparent material layer and positioned a first distance from the light incident surface, the first distance being no less than 65 μm, and
a second recording layer arranged within the transparent material layer and positioned a second distance from the light incident surface, the second distance being greater than the first distance and not greater than 113 μm; and
a controller arranged and configured for controlling the optical pickup for writing data to and reading data from at least one of the first and second recording layers.

13. An apparatus according to claim 12, wherein:
the first distance is no less than 70 μm; and
the second distance is no greater than 108 μm.

14. An apparatus for writing to or reading from a recording medium, according to claim 12, wherein:
the optical pickup includes
a light source for generating and emitting light and
a lens arranged and configured to receive the light from the light source and produce a beam of light, the beam of light being directed through the light incident surface and focused onto the first and second recording layers.

15. An apparatus for writing to or reading from a recording medium, according to claim 14, wherein:
the light emitted by the light source has a wavelength of approximately 405 nm, and
the lens has an axis, the axis having a substantially perpendicular orientation relative to the first and second recording layers.

16. An apparatus for writing to or reading from a recording medium, according to claim 15, wherein:
the axis is offset from a perpendicular orientation by no more than 0.6 degrees.

17. An apparatus for writing to or reading from a recording medium, according to claim 12, wherein:
interaction of the lens, the light source and the recording medium produces a wave front aberration (WFA) of less than 0.075 λrms.

18. A high-density multi-layer recording medium, comprising:
a substrate including a transparent material layer and having a light incident surface, an opposite surface and a substrate thickness corresponding to a distance between the light incident surface and the opposite surface;
a first recording layer; and
a second recording layer, wherein
the first and second recording layers are located within the transparent material layer between the light incident surface and above a central plane generally parallel to the light incident surface that bisects the substrate thickness; and further wherein:
the first recording layer and the second recording layer are separated by a distance of between 14 μm and 30 μm and arranged symmetrically about a recording layer plane, the recording layer plane being parallel to the light incident surface.

19. A high-density multi-layer recording medium according to claim 18, wherein:
the first recording layer and the second recording layer are separated by a distance of between 14 μm and 24 μm.

20. A high-density multi-layer recording medium according to claim 18, wherein:
the first recording layer and the second recording layer are separated by a distance selected from a group of ranges consisting of 19+/−5 μm and 25+/−5 μm.

21. The high-density multi-layer recording medium according to claim 18, wherein:
the recording layer plane is arranged about 0.10 mm from the light incident surface.

22. The high-density multi-layer recording medium according to claim 21, wherein:
the first recording layer and the second recording layer are separated by a distance of about 20 μm.

23. The high-density multi-layer recording medium according to claim 22, wherein:
the first recording layer is about 0.09 mm from the light incident surface; and
the second recording layer is about 0.11 mm from the light incident surface.

24. A high-density multi-layer recording medium, comprising:
a substrate including a transparent material layer and having a light incident surface, an opposite surface and a substrate thickness corresponding to a distance between the light incident surface and the opposite surface;
a first recording layer, and
a second recording layer, wherein
the recording layers are located within the transparent material layer between the light incident surface and a central plane generally parallel to the light incident surface that bisects the disc thickness; and further wherein:
the first recording layer is located at a first distance of at least 68.5 μm from the light incident surface and the second recording layer is located at a second distance from the light incident surface, the second distance being greater than the first distance but no more than 110.5 μm from the light incident surface.

25. The high-density multi-layer recording medium according to claim 24, wherein the first recording layer and the second recording layer are separated from each other by a distance between 14 μm and 24 μm.

26. The high-density multi-layer recording medium according to claim 24, wherein:
the first distance encompasses a first range of distances, the first range spanning no more than 10 μm; and
the second distance encompasses a second range of distances, the second range spanning no more than 10 μm.

27. The high-density multi-layer recording medium according to claim 24, wherein:
the transparent material layer has a refractive index between about 1.45 and 1.70.

28. The high-density multi-layer recording medium according to claim 27, wherein:
a separation distance between the first and second recording layers is between 14 μm and 24 μm.

29. A high-density multi-layer recording medium, comprising:
a transparent layer, the transparent layer having an index of refraction between 1.45 and 1.70 and a light incident surface;
a first recording layer arranged within the transparent layer and at least 70 μm from the light incident layer; and
a second recording layer arranged within the transparent layer further from the light incident surface than the first recording layer and no more than 108 μm from the light incident layer.

30. The high-density multi-layer recording medium according to claim 29, wherein a separation distance between the first and second recording layers is between 14 μm and 24 μm.

31. The high-density multi-layer recording medium according to claim 29, wherein:
the index of refraction is about 1.45;
the first recording layer is at least 68.5 μm from the light incident surface; and
the second recording layer is no more than 106.5 μm from the light incident surface.

32. The high-density multi-layer recording medium according to claim 29, wherein:
the index of refraction is about 1.70;
the first substrate thickness is at least 71.4 μm; and
the second substrate thickness is no greater than 110.5 μm.

33. An apparatus for writing to or reading from a multi-layer recording medium, comprising:
an optical pickup arranged and configured to write data to or read data from the recording medium; wherein
the recording medium includes a transparent layer, the transparent layer having an index of refraction between 1.45 and 1.70, a light incident surface, a first recording layer arranged within the transparent layer and separated from the light incident layer by a first substrate thickness of no less than 70.0 μm, and a second recording layer arranged within the transparent layer and separated from the light incident surface by a second substrate thickness that is greater than the first substrate thickness but no more than 108.0 μm, the first and second recording layers being separated by a distance between 14 μm and 30 μm; and
a controller arranged and configured for controlling the pickup to write data to read data from at least one of the first and second recording layers.

34. A high-density multi-layer recording medium according to claim 33, wherein:
the first recording layer and the second recording layer are separated by a distance of between 14 μm and 24 μm.

35. A high-density multi-layer recording medium according to claim 33, wherein:
the first recording layer and the second recording layer are separated by a distance selected from a group of ranges consisting of 19+/−5 μm and 25+/−5 μm.

36. An apparatus for recording or reproducing to or from an optical recording medium, according to claim 33, wherein:
the optical pickup further comprises a light source and a lens arranged and configured to direct a focused beam of light through the light incident surface and onto the first and second recording layers comprising.

37. An apparatus for recording or reproducing to or from an optical recording medium, according to claim 36, wherein:
the light source emits a light having a wavelength of approximately 405 nm and
the lens has an axis arranged in a substantially perpendicular orientation to the first and second recording layers.

38. An apparatus for recording or reproducing to or from an optical recording medium, according to claim 37, wherein:
the axis is offset from a perpendicular orientation by no more than 0.6 degrees.

39. An apparatus for recording or reproducing to or from an optical recording medium, according to claim 33, wherein:
interaction of the lens, the light source and the optical recording medium produces a wave front aberration (WFA) of less than 0.075 λrms.

40. An apparatus for writing to or reading from an optical recording medium, comprising:
an optical pickup arranged and configured to write data to or read data from the optical recording medium; wherein
the optical recording medium includes a transparent layer, the transparent layer having an index of refraction between 1.45 and 1.70, a light incident surface, a first recording layer arranged within the transparent layer and separated from the light incident surface by a first substrate thickness of no less than 68.5 μm and a second recording layer arranged within the transparent layer and separated from the light incident surface by a second substrate thickness greater than the first substrate thickness but no more than 110.5 μm, the first and second recording layers being separated by a distance between 14 μm and 30 μm; and
a controller arranged and configured for controlling the pickup to write data to read data from at least one of the first and second recording layers.

41. A high-density multi-layer recording medium according to claim 40, wherein:
the first recording layer and the second recording layer are separated by a distance of between 14 μm and 24 μm.

42. A high-density multi-layer recording medium according to claim 40, wherein:
the first recording layer and the second recording layer are separated by a distance selected from a group of ranges consisting of 19+/−5 μm and 25+/−5 μm.

43. An apparatus for recording or reproducing to or from an optical recording medium, according to claim 40, wherein:
the optical pickup further comprises a light source and a lens arranged and configured to direct a focused beam of light through the light incident surface and onto the first and second recording layers comprising.

44. An apparatus for recording or reproducing to or from an optical recording medium, according to claim 43, wherein:
the light source emits a light having a wavelength of approximately 405 nm and
the lens has an axis arranged in a substantially perpendicular orientation to the first and second recording layers.

45. An apparatus for recording or reproducing to or from an optical recording medium, according to claim 44, wherein:
the axis is offset from a perpendicular orientation by no more than 0.6 degrees.

46. An apparatus for recording to or reproducing from an optical recording medium, according to claim 42, wherein:
interaction of the lens, the light source and the optical recording medium produces a wave front aberration (WFA) of less than 0.075 λrms.

47. A high-density multi-layer recording medium comprising:
a substrate;
a first reflective layer formed on the substrate;
a first recording layer L1 formed on the first reflective layer;
a spacer layer formed on the first recording layer, the spacer layer having an index of refraction of between about 1.45 and 1.70;
a second reflective layer formed on the spacer layer;
a second recording layer L2 formed on the second reflective layer;
a cover layer formed on the second recording layer, the cover layer having an index of refraction of between about 1.45 and 1.70; and
a light incident surface provided on or above a surface of the cover layer,
wherein the layers arranged between the light incident surface and the first recording layer form a first transmission stack and the layers arranged between the light incident surface and the second recording layer comprise a second transmission stack, and
further wherein the first transmission stack has a first thickness of no more than 108 μm, the second transmission stack has a second thickness of at least 68 μm and less than the first thickness, a difference between the first thickness and second thickness being no more than 30 μm and no less than 14 μm.

48. A high-density multi-layer recording medium according to claim 47, wherein:
the first recording layer and the second recording layer are separated by a distance of between 14 μm and 24 μm.

49. A high-density multi-layer recording medium according to claim 47, wherein:
the first recording layer and the second recording layer are separated by a distance selected from a group of ranges consisting of 19+/−5 μm and 25+/−5 μm.

50. A high-density multi-layer recording medium, comprising:
a substrate including a transparent material layer, the transparent material layer having a light incident surface, an opposite surface and a substrate thickness corresponding to a distance between the light incident surface and the opposite surface;
a first recording layer;
an intermediate recording layer; and
a last recording layer, wherein
the recording layers are located within the transparent material layer between the light incident surface and a central plane generally parallel to the light incident surface that bisects the substrate thickness; and further wherein:
the first recording layer is located at least about 63.5 μm from the light incident surface;
the last recording layer is located between the first recording layer and the central plane and no more than about 115.5 μm from the light incident surface, the first and last recording layers being separated by a distance between 14 μm and 30 μm; and
the intermediate recording layer is located between the first recording layer and the last recording layer.

51. A high-density multi-layer recording medium according to claim 50, wherein:
the first recording layer and the second recording layer are separated by a distance of between 14 μm and 24 μm.

52. A high-density multi-layer recording medium according to claim 50, wherein:
the first recording layer and the second recording layer are separated by a distance selected from a group of ranges consisting of 19+/−5 μm and 25+/−5 μm.
